(19) United States
(12) Patent Application Publication
(10) Pub. No.: US 2013/0186924 A1
(43) Pub. Date: Jul. 25, 2013

(54) Passenger-Accessible, Flexible Portable Motorcycle Organizer Pouch

(71) Applicants: James S. Bone, Gladstone, MO (US); Lisa J. Bone, Gladstone, MO (US)

(72) Inventors: James S. Bone, Gladstone, MO (US); Lisa J. Bone, Gladstone, MO (US)

(21) Appl. No.: 13/358,331

(22) Filed: Jan. 25, 2012

(51) Int. Cl. B62J 9/00

(52) U.S. Cl. 224/413

(57) ABSTRACT

An organizer pouch installed on a backrest of a seat of a motorcycle operator. The pouch has a smooth, flat front surface that fits over and covers the forward part of the backrest without changing the contour of the backrest. The pouch has a back containing pockets, closures, holders, and other devices or attachments for removably housing, storing, and securing useful items during travel, including while the motorcycle is in motion. When so located and installed, a passenger seated in a passenger seat behind the operator's seat has full access to the items stored in the pouch and may retrieve the items for the passenger's use or the operator's use during travel.

### FIELD OF INVENTION

The field of the invention is a passenger accessible motorcycle pouch.

### BACKGROUND

Motorcycles have a seat for the operator of the motorcycle. The operator's seat usually has a padded backrest for the operator; the backrest is supported on the structure of the motorcycle or the motor cycle seat. Frequently, there is a second seat immediately behind the operator's seat to accommodate a passenger. Motorcycles also frequently have sissy bars, or passenger back rests that are located on or near the rear of the motorcycle. When traveling by motorcycle it is often necessary or desirable to provide a device or structure to accommodate and secure the luggage, backpack, or other equipment, goods, and accessories of the rider and passenger.

There are a variety of attachable packs and luggage carriers used for carrying goods and personal items on motorcycles. Examples are shown in the following patents:

Lovett U.S. Pat. No. D479,186 discloses an attachable carrier attached to a sissy bar;

Grandy et al U.S. Pat. No. 7,255,252 discloses a carrier attachable to a sissy bar;

Lovitt U.S. Pat. No. 8,011,542 discloses a carrier attachable to a sissy bar;

Lovett U.S. Pat. No. 6,123,239 discloses a carrier attachable to a sissy bar or a rear passenger seat; and

Smith U.S. Pat. No. 6,547,114 discloses a carrier attachable to a sissy bar or rear passenger seat.

The carriers, packs, and luggage frames disclosed attach to a sissy bar or rear passenger seat and are accessible to neither the operator nor passenger of the motor cycle while the motorcycle is in motion. Some of the carriers require frames or special attachments. The attachment devices of some of these carriers are inflexible, require special attaching structure, or are designed primarily for large bulky loads. Others of the carriers require structural attachments to the motorcycle frame or sissy bars or require the use of straps, ties, or other attachment members.

### SUMMARY OF INVENTION

A zippered pouch is provided for enclosing a seatback or backrest of the seat of the operator of a motorcycle. The pouch slips over and down upon the backrest of the operator's seat. The pouch has a smooth, flat front surface that fits over and covers the forward part of the backrest without changing the contour of the backrest. The operator may, thus, lean back against the backrest without making contact with goods or other items placed, stored or secured in the pouch.

The pouch has a backside containing pockets, closures, holders, and other devices or attachments for removably housing, storing, and securing useful items during travel. The backside of the pouch faces toward the rear of the motorcycle. So located and installed on the operator's backrest, a passenger seated in a passenger seat behind the operator's seat has full access to the items stored in the pouch and may retrieve the items for the passenger's use or the operator's use during travel.

The pouch may be used in lieu of, or in addition to, a luggage carrier secured to the sissy bars of the motorcycle.

### BRIEF DESCRIPTION OF DRAWINGS

FIG. 1 is a perspective rear view of the pouch of the invention installed on a backrest of a seat of an operator of a motorcycle.

FIG. 2 is a front view of the pouch showing it being placed on the backrest of the operator's seat for installation thereon with a zipper of the pouch unzipped.

FIG. 3 is a front view of the pouch showing the pouch partially installed on the backrest of the operator's seat of the motorcycle with the zipper of the pouch unzipped.

FIG. 4 is a front view of the unzipped pouch fully installed on the backrest of the operator's seat of the motorcycle with the zipper of the pouch unzipped.

FIG. 5 is a left side view of the pouch installed on the backrest of the operator's seat of the motorcycle showing the zipper of the pouch unzipped.

FIG. 6 is a left side view of the pouch installed on the backrest of the operator's seat of the motorcycle showing the zipper of the pouch zipped.

FIG. 7 is a front view of the pouch fully installed on the backrest with showing the zipper of the pouch fully zipped.

FIG. 8 is a bottom view of the pouch showing the zipper fully zipped and showing bottoms of certain pockets, closures, holders, and other devices for removably housing, storing, and securing useful items during travel.

FIG. 9 is a rear view of the pouch showing certain pockets, closures, holders, and other devices for removably housing, storing, and securing items during travel.

### DETAILED DESCRIPTION

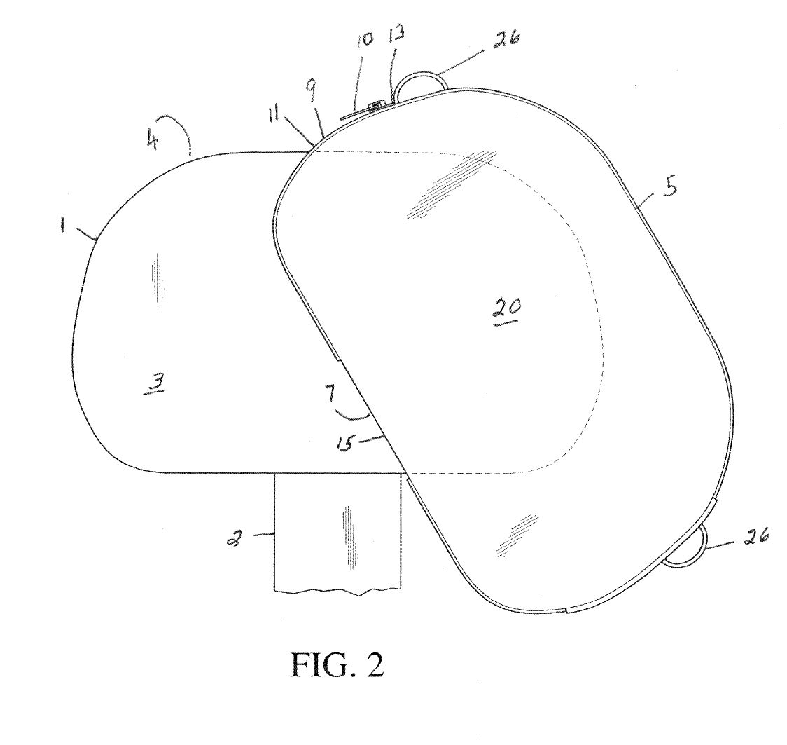

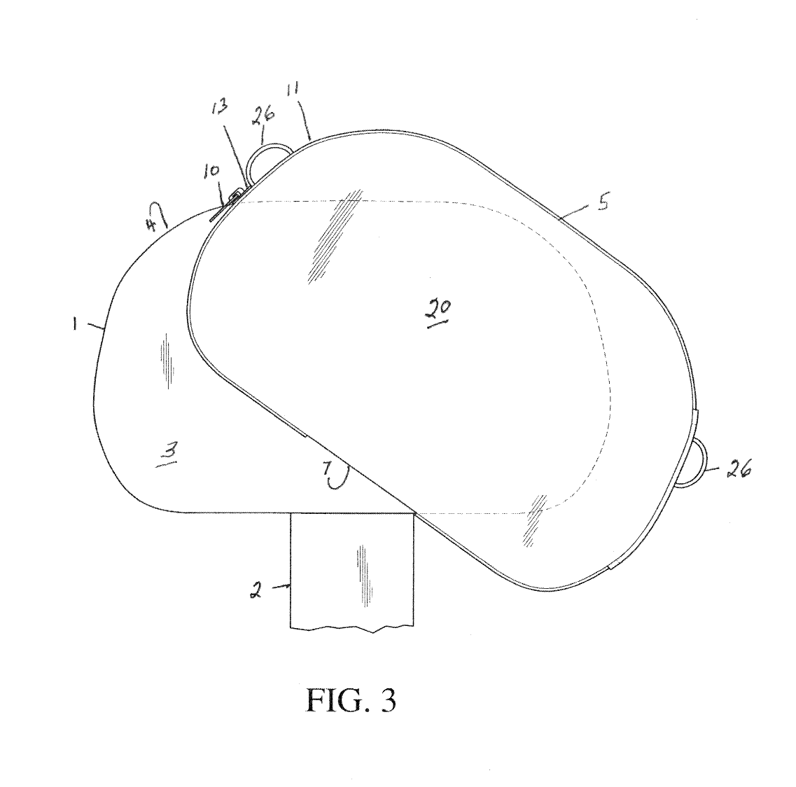

FIGS. 2 and 3 show a padded backrest 1 for an operator of a motorcycle. The backrest 1 is secured to the structure of the motorcycle or operator's seat by a support 2. The backrest has a forward facing front 3 and a rear facing back 4. Terms such as “front”, “rear”, “back”, “front facing”, “forward facing”, “forward”, and “rear facing”, as used herein, refer to the direction of travel of the motorcycle. Thus, “front”, “front facing”, “forward”, and “forward facing” refer to the surfaces, sides, and directions facing the direction of forward travel of the motorcycle, and “rear”, “back”, and “rear facing” refer to the surfaces, sides, and directions opposite the direction of forward travel of the motorcycle.

As further shown in FIGS. 2 and 3, an organizer/pouch 5 forms an inside cavity 7.

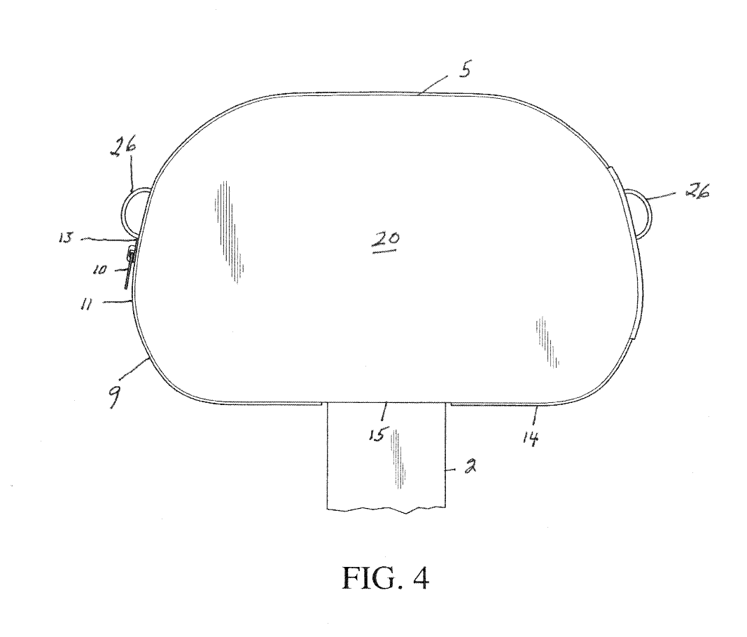

The pouch 5 has a zipper 9 that extends along a side 11 of the pouch 5 and is zipped and unzipped by pulling a pull tab 10. The zipper 9 extends from an approximate mid portion 13 of the side 11 of the pouch 5 to a bottom 14 of the pouch 5. When the zipper 9 is opened, as shown in FIGS. 2 and 3, the inside cavity 7 of the pouch 5 is exposed, and the pouch 5 is opened so that the pouch 5 may be installed, pulled, or slipped over the backrest 1, as shown successively in FIGS. 2, 3 and 4. Of course, a drawstring, snaps, clips, buckles, or other type of closure device may be used instead of a zipper.

When the pouch 5 fully covers the backrest 1, the zipper 9 is closed by pulling the pull tab 10 from the mid portion 13 of side 11 of the pouch 5 to the bottom 14 of the pouch 5 to secure the pouch 5 to the backrest 1.

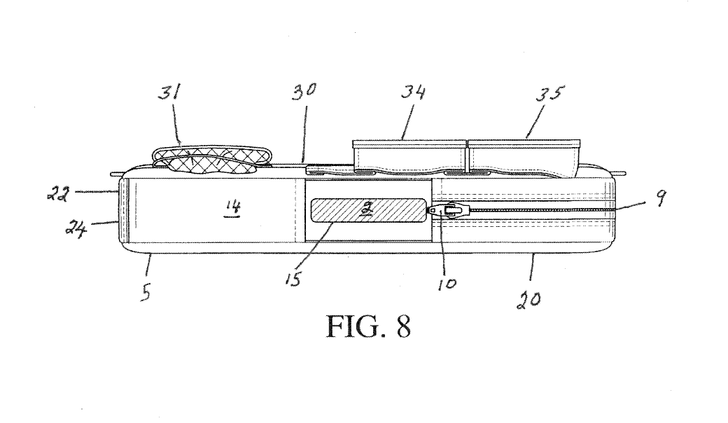

The pouch 5 may be made of leather, plastic, cloth, canvas, synthetic fabric, or other flexible material that will form to the contour of the backrest 1. As shown in FIG. 8, the pouch 5 may also have an opening 15 on the bottom 14 to accommodate the motorcycle support 2. When installed, the pouch 5 assimilates and assumes the shape of the backrest 1.

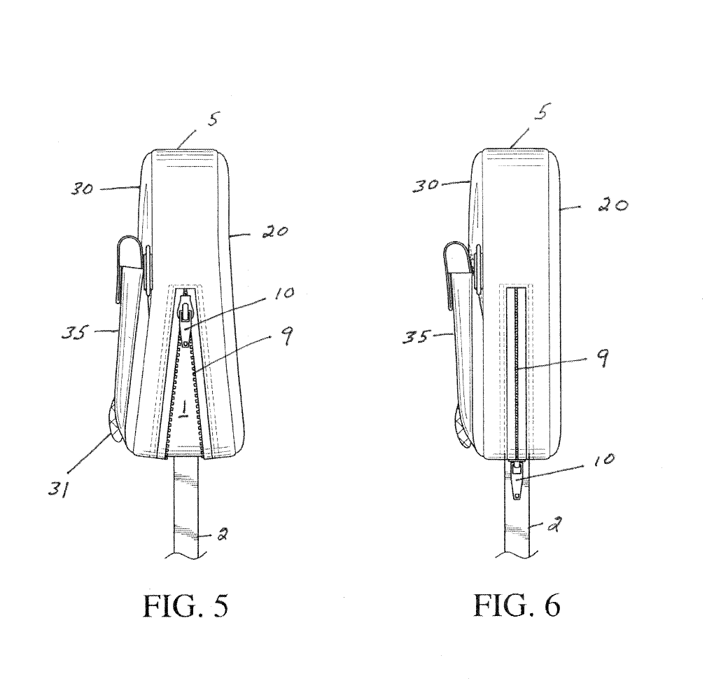

FIGS. 2 through 6 show the forward-facing or front 20 of the pouch 5. The front 20 of the pouch 5 is substantially smooth and unobstructed, having no protrusions or pockets. The front 20 of the pouch 5, thus, covers and assumes the contour of the front of the operator's backrest 1 so that the operator may use the backrest 1 without having protrusions or obstructions that could dig into or impinge upon the operator's back while resting against the backrest 1.

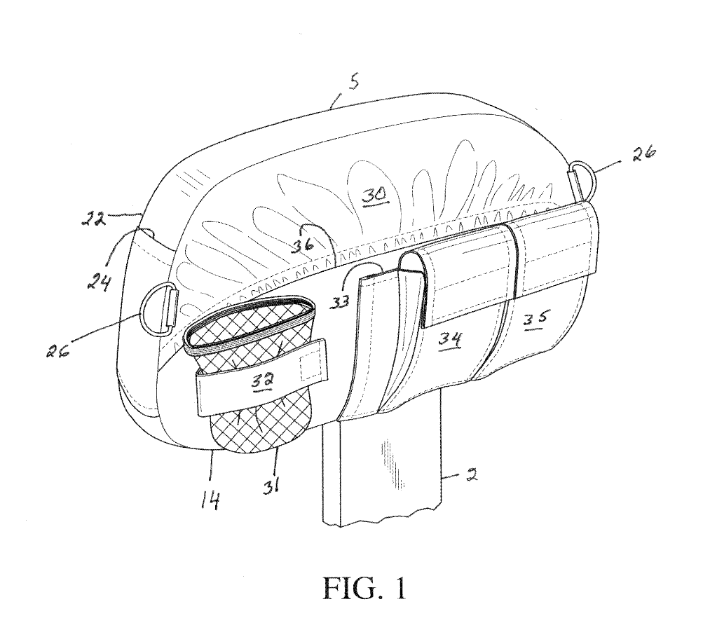

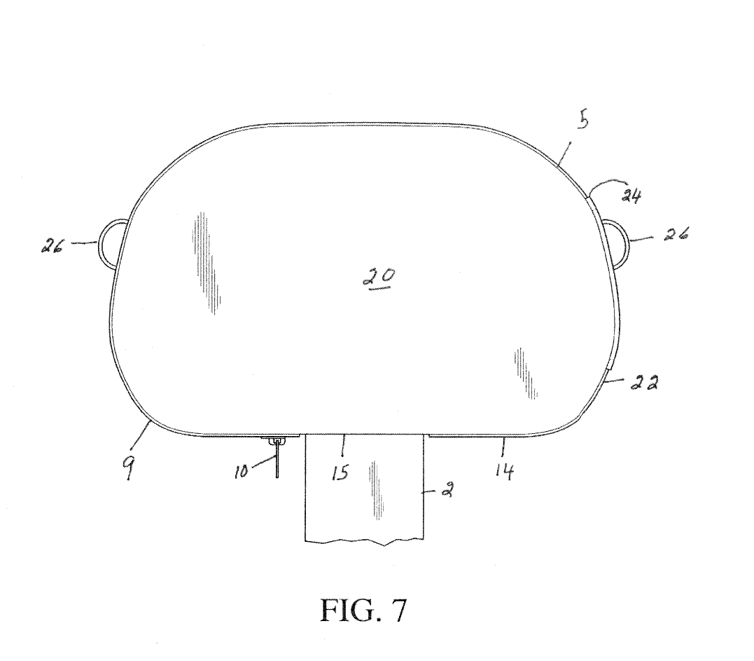

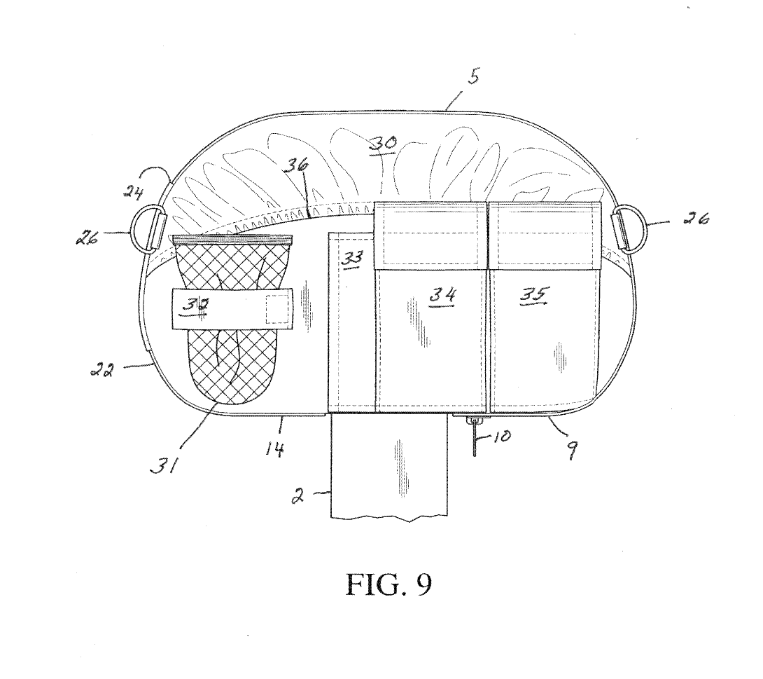

As shown in FIGS. 1, 3, 7 and 9, a side 22 of the pouch 5 opposite the zipper 9 may contain a side pocket 24 to hold objects such as money, pens, pencils, sunglass bows, candy, or other objects that fit into the side pocket 24. Side rings 26 may also be installed on the pouch 5 to accommodate objects such as key rings, openable clips, hooks, purses (via straps), and other objects that may be tied or attached to the side rings 26.

As shown in FIGS. 1, 5, 6, 8, and 9, a rear-facing back 30 of the pouch 5 contains numerous holders, pockets, enclosures, holders, and containers to house, store, and secure objects and goods. These pockets, enclosures, holders, and containers may include a bottle holder 31 for a water (or other) bottle; the bottle holder 31 may include a secured strap 32 with a hook and loop enclosure to secure the bottle in the bottle holder 31.

An additional slim pocket 33 is included for storage of objects such as pencils, pens, or other similarly shaped objects.

Flapped enclosures 34 and 35 may be built into the back 30 of the pouch 5 to hold objects such as iPods, smartphones, wallets, GPS units, and other similarly shaped objects; the flaps of such enclosures 34 and 35 may be secured, if desired, by hook and loop enclosures or other types of fasteners such as drawstrings, snaps, buckles, zippers, and clips of various types.

A large pocket 36 may be included just above the pockets and holders 31, 33, 34, and 35 for larger objects such a check books, iPads, small computers, glasses, GPS units, clothing items, and the like.

As will be appreciated, when the back 30 and the side 22 of the pouch 5 are provided with the holders 31, 33, 34, and 35, the side pocket 24, and the rings 26, the pouch 5 comprises an organizer which not only allows objects to be housed, stored, and secured, but also organizes the objects so that they may be easily found and retrieved while the motorcycle is at rest or in motion. The organizing feature of the organizer pouch 5 reduces the need to search for objects desired to be retrieved and used while they are in the organizer pouch 5, allowing the passenger to retrieve them quickly and with safety rather than rummaging through an unorganized collection of objects

Of course, the back 30 of the pouch 5 may contain other types, arrangements, sizes, configurations, and styles of pockets, enclosures, holders, and containers to house, store, and secure objects and goods. In addition, the pouch 5 may be made with a single large pocket, or any other combination of pockets or closures on the back 30 of the pouch 5.

In use, the zipper 9 is unzipped to expose the interior cavity 7 of the pouch 5. The pouch 5 is then installed on the backrest 1 by slipping the pouch 5 over the backrest 1, as shown sequentially in FIGS. 2, 3 and 4. The zipper 9 is then closed or zipped as shown in FIGS. 6-9. Objects and goods may then be placed and secured on or in rings 26 and pockets and closures 24, 31, 33, 34 and 35 as needed and desired.

When not needed on the backrest 1, the pouch 5 may be removed from the backrest 1 by unzipping the zipper 9 and pulling the pouch 5 off of the backrest 1, with or without removing the objects and goods from the holders.

Since the pouch 5 is flexible, it may be folded, rolled, collapsed, and compacted and stored in a garment pocket, tote, purse, backpack, duffle bag, or other luggage or carrier. In the alternative, a strap may be attached to one or both of the rings 26 and the pouch 5 may be used as a tote, purse, handbag, or other portable carrying case by a user, with the goods and objects remaining in the pouch or removed and replaced by other goods and objects.

In the alternative, if portability is not desired, the pouch 5 may be permanently affixed to the backrest of the motorcycle, such as by sewing it onto the backrest 1 or by securing it to the support 2 with a bolted bracket or other means of attachment.

It will be noted that the pouch 5, due to its smooth, unobstructed front side 20, permits use of the pouch 5 without any impingement on the back of the operator of the motorcycle, and, thus, does not interfere in any way with the comfort or back support of the operator. All of the objects stored in the pouch 5 are on the back 30 of the pouch 5. Since the objects stored in the pouch 5 are confined to the back 30 of the pouch 5 and, thus, the rear of the backrest 1, the objects do not interfere with or impinge upon the body of the passenger or the passenger's legs while riding the motorcycle.

The pouch 5 is fully installable and removable from the backrest 1 of the motorcycle operator's seat without changes or fixed attachments to the structure or operator's seat.

In addition, each and every object stored and transported in the pouch 5 is fully accessible to the passenger on the motorcycle. The accessibility of the items make it possible for the passenger to secure and remove the goods and objects for use by the passenger or operator while the motorcycle is in motion, making it unnecessary to stop the motorcycle in order to get a drink of water, apply sunscreen, get sunglasses, consult a GPS device, use music devices such as iPods and small radios, secure a pen or pencil, access cash or wallets for quick stops and drive-ins, make a telephone call, or engage in other activities during travel. As noted, the organizer pouch 5 enhances the safety of a portable carrier, because the passenger can get objects needed by the operator, eliminating the need for the operator to turn around, wiggle, or reach behind the operator's back to secure a necessary or desirable object and risking loss of control of the motorcycle due to the necessity to reach back or wiggle in the operator's seat in order to secure the use of the object.

It will be further noted that the pouch 5 may be decorated or otherwise adorned to the personal tastes and desires of a user.

What is claimed is as follows:

1. A device securable to the backrest of the operator's seat of a motorcycle, the backrest having a back and a front, the device comprising:
(a) a flexible pouch, the pouch having a back and an unobstructed front;
(b) a closure device for opening and closing the pouch;
(c) the pouch, when opened, is placed over and around the backrest such that the unobstructed front of the pouch is immediately adjacent to and covers the front of the backrest; and
(d) at least one holder on the back of the pouch for containing one or more objects.

2. The device of claim 1 wherein the flexible pouch is made of one or more of leather, plastic, cloth, canvas, synthetic fabric, or a combination thereof.

3. The device of claim 1 wherein the closure device is a zipper.

4. The device of claim 1 wherein the closure device is at least one of drawstrings, snaps, buckles clips, or a combination thereof.

5. The device of claim 1 wherein the pouch contains an opening in a bottom thereof to accommodate a support of the backrest.

6. The device of claim 1 wherein the unobstructed front is substantially smooth and has no protrusions or pockets thereon.

7. The device of claim 1 wherein the pouch is removable from the backrest and may be rolled, folded, collapsed, or compacted.

8. The device of claim 1 wherein the pouch has rings on opposite sides thereof

9. The device of claim 1 wherein the pouch has a pocket on a side thereof

10. The device of claim 1 wherein the at least one holder is at least one of a pocket, a flapped closure, a large pocket, a bottle holder, or a pencil holder.

11. The device of claim 1 wherein the holders are sized to contain at least one of a water bottle, a bottle of sunscreen, sunglasses, a GPS system, a music playing device, an iPod, a small radio, a pen or pencil, cash, or a wallet.

12. The device of claim 1 wherein the pockets and objects contained therein do not interfere with or impinge upon the body or the operator or the passenger of the motorcycle.

13. The device of claim 1 wherein all of the objects that may be stored in the holders are accessible to a passenger of the motorcycle while the motorcycle is in motion.

14. The device of claim 1 wherein the back of the pouch comprises an organizer of objects placed in the holders.

15. An organizer pouch securable to the backrest of the operator's seat of a motorcycle, the motorcycle having a passenger seat behind the operator's seat, the backrest having a back and a front, the organizer pouch comprising:
(a) an unobstructed front, a back, a bottom, and opposite sides forming an interior cavity for containing the backrest;
(b) a device on the organizer pouch for closing the organizer pouch around the backrest when the backrest is in the cavity;
(c) at least one holder on the back of the pouch for containing one or more objects;
wherein, when the organizer pouch is around the backrest such that the unobstructed front of the pouch is immediately adjacent to and covers the front of the backrest, the passenger may remove objects from the at least one holder while the motorcycle is in motion.

16. The organizer pouch of claim 15 wherein the device for closing the organizer pouch is at least one of a zipper, drawstrings, snaps, buckles clips, or a combination thereof.

17. The organizer pouch of claim 15 wherein the pouch is removable from the backrest and may be rolled, folded, collapsed, or compacted.

18. The organizer pouch of claim 15 wherein the pouch has at least one of a pocket or rings secured to at least one of the sides.

19. The organizer pouch of claim 15 wherein the at least one holder is at least one of a pocket, a flapped closure, a large pocket, a bottle holder, or a pencil holder.

20. The organizer pouch of claim 15 wherein the holders are sized to contain at least one of a water bottle, a bottle of sunscreen, sunglasses, a GPS system, a music playing device, an iPod, a small radio, a pen or pencil, cash, or a wallet.
